(19) United States
(12) Patent Application Publication
(10) Pub. No.: US 2019/0270680 A1
(43) Pub. Date: Sep. 5, 2019

(54) SYSTEM AND METHOD FOR ALPACA ORGANIC PLANT FOOD FORMULATION

(71) Applicant: Alpaca Grow, LLC, Quechee, VT (US)

(72) Inventor: Brian MATTEI, Hartland, VT (US)

(21) Appl. No.: 15/911,083

(22) Filed: Mar. 3, 2018

(51) Int. Cl. C05F 3/00

(52) U.S. Cl. CPC C05F 3/00

(57) ABSTRACT

A system and method for alpaca organic plant food formulation is disclosed. A method of an example embodiment includes: feeding alpaca with second cut hay to eliminate weed seed in manure produced by the alpaca; gathering and screening the alpaca manure using a large mesh screen; storing the screened alpaca manure in a ventilated holding box; retrieving the screened alpaca manure from the ventilated holding box and washing the screened alpaca manure with water to remove debris; loading the screened and washed alpaca manure into a freeze-dryer machine and freeze-drying the alpaca manure in stages over a period of time; loading the freeze-dried alpaca manure into a grinder and grinding the alpaca manure into a fine powder form using the grinder; sifting the ground alpaca manure powder using a sifter to remove unwanted chunks of material; combining the sifted powdered alpaca manure with worm castings to form an alpaca organic plant food formulation; and packaging the alpaca organic plant food formulation using a powder filling machine.

### TECHNICAL FIELD

The disclosed subject matter relates to the fertilizer production, organic fertilizer, plant foods, and particularly although not exclusively, to a system and method for alpaca organic plant food formulation.

### COPYRIGHT

A portion of the disclosure of this patent document contains material that is subject to copyright protection. The copyright owner has no objection to the facsimile reproduction of the patent document or the patent disclosure, as it appears in the U.S. Patent and Trademark Office patent files or records, but otherwise reserves all copyright rights whatsoever. The following notice applies to the disclosure provided herein and to the drawings that form a part of this document: Copyright 2016-2018, Alpaca Grow, LLC; All Rights Reserved.

### BACKGROUND

There are a number of disadvantages associated with chemical fertilizers. Chemical fertilizers are primarily made from nonrenewable sources, including fossil fuels. Chemical fertilizers grow plants but do not sustain the soil. The fillers in chemical fertilizers do not promote life or soil health, and do not include the decaying matter necessary to improve soil structure. In fact, chemical fertilizers don't replace many trace elements that are gradually depleted by repeated crop plantings, resulting in long-term damage to the soil. Because the nutrients are readily available, there is a danger of over fertilization. This not only can kill plants but upset the entire ecosystem. Chemical fertilizers tend to leach, or filter away from the plants, requiring additional applications. Repeated applications may result in a toxic buildup of chemicals such as arsenic, cadmium, and uranium in the soil. These toxic chemicals can eventually make their way into consumer fruits and vegetables. Long-term use of chemical fertilizer can change the soil pH, upset beneficial microbial ecosystems, increase pests, and contribute to the release of greenhouse gases.

Organic fertilizers are much better for the environment as these organic fertilizers release nutrients into the soil as they break down, improving the structure of the soil and increasing its ability to hold water and nutrients. Over time, organic fertilizers make both the soil and plants healthy and strong. Organic fertilizers do not produce toxic buildups of chemicals and salts that can be deadly to plants. Organic fertilizers are renewable, biodegradable, sustainable, and environmentally friendly. However, some organic fertilizers are made with organic material that contains extraneous seeds that can contaminate a planting with which the fertilizer is used. Many organic fertilizers produce noxious odors and unpleasant environments. Other organic fertilizers can attract unwanted animals.

### BRIEF DESCRIPTION OF THE DRAWINGS

Embodiments are illustrated by way of example and not limitation in the figures of the accompanying drawings, in which:

FIG. 1 illustrates the large mesh screen used to remove debris according to an example embodiment;

FIG. 2 illustrates a ventilated holding box according to an example embodiment;

FIG. 3 illustrates a freeze-dryer machine according to an example embodiment;

FIG. 4 illustrates a grinder or grinding apparatus according to an example embodiment;

FIG. 5 illustrates a sifter or automatic sifting apparatus according to an example embodiment;

FIG. 6 illustrates a powder filling machine according to an example embodiment; and

FIG. 7 illustrates a flow diagram representing a sequence of operations performed in a method according to an example embodiment.

### DETAILED DESCRIPTION

In the following detailed description, reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

According to various example embodiments of the disclosed subject matter as described herein, there is disclosed, illustrated, and claimed a system and method for alpaca organic plant food formulation. The example embodiments disclosed herein provide a system and method for gathering, storing, cleaning, freeze-drying, grinding, sifting, blending, and packaging organic waste material or manure from alpacas. Even with its lower organic content, alpaca manure is considered a rich soil conditioner. Alpaca fertilizer improves the soil quality and its ability to retain water. Alpaca fertilizer is also good for plants, providing a fair amount of nitrogen and potassium and about average levels of phosphorus. The nitrogen and potassium content of alpaca dung is comparatively high, an indication of good fertilizer value. Nitrogen, phosphorus and potassium are the major plant nutrients. Phosphorus is relatively low as in most livestock manure. The calcium and magnesium content is about average. Thus, unlike manure from other animals, alpaca fertilizer provides a better and perfectly balanced combination of nutrients for beneficial plant growth. Moreover, alpaca fertilizer has a long shelf life, doesn't attract animals or insects, and does not produce unpleasant odors or other side effects. Finally, given the manner in which the alpaca is fed as part of the organic plant food formulation process described below, the resulting alpaca fertilizer does not contain weed seeds that can contaminate a planting environment. Because there are no weed seeds in the fertilizer, there is no need to apply herbicides for weeds for at least a month after the alpaca fertilizer is applied.

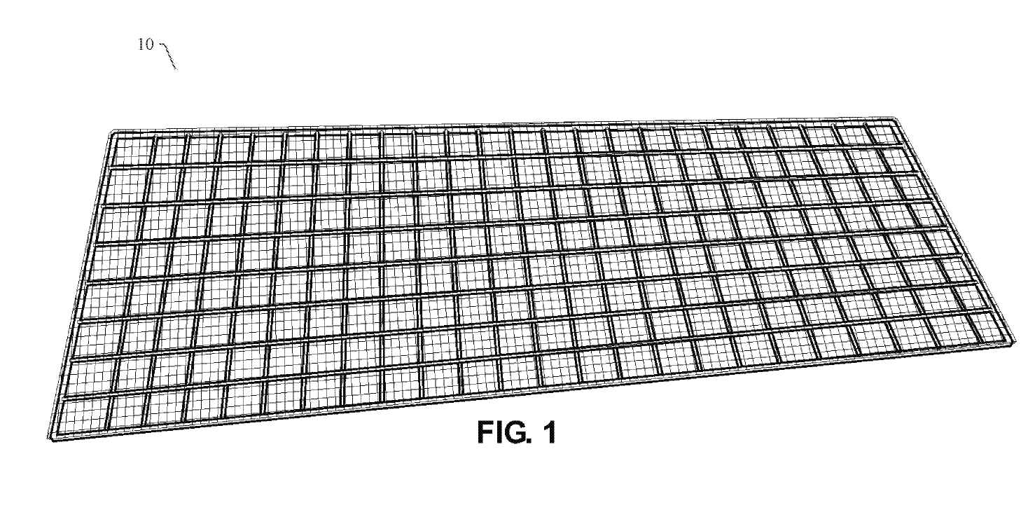

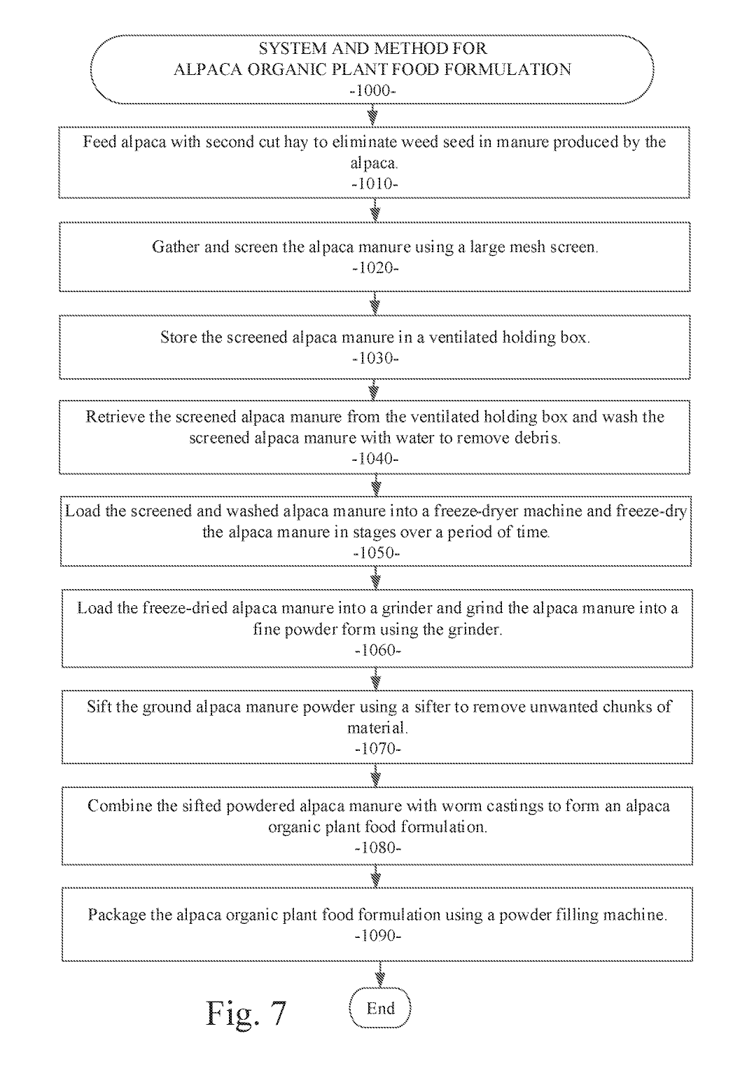

Referring now to FIGS. 1 through 7, example embodiments of the system and method for alpaca organic plant food formulation are illustrated. In a first step of the alpaca organic plant food formulation process of an example embodiment, the alpaca are fed in a manner that results in both the production of high levels of beneficial nutrients and the absence of weed seeds in the alpaca manure. In an example embodiment of the alpaca organic plant food formulation process, the alpaca are fed with second cut hay to eliminate weed seed in the manure. The second cut of the hay results in feed that is lacking weed seeds. Thus, the feed consumed by the alpaca does not contain weed seeds, which can pass through to the alpaca manure. In some cases, the alpaca an also be fed with occasional carrots and apples.

In a second step of the alpaca organic plant food formulation process of an example embodiment, the alpaca manure is gathered and screened using a using large mesh screen. FIG. 1 illustrates the large mesh screen 10 used in an example embodiment to remove debris from the gathered alpaca manure. In the example embodiment, the alpaca manure is gathered and screened for debris using a ¼ inch large mesh screen 10 to remove bedding hay and straw. In the example embodiment, the large mesh screen 10 can be six feet long by two feet wide with a ¼ inch mesh screen. It will be apparent to those of ordinary skill in the art in view of the disclosure herein that the large mesh screen 10 can be in other dimensions as well.

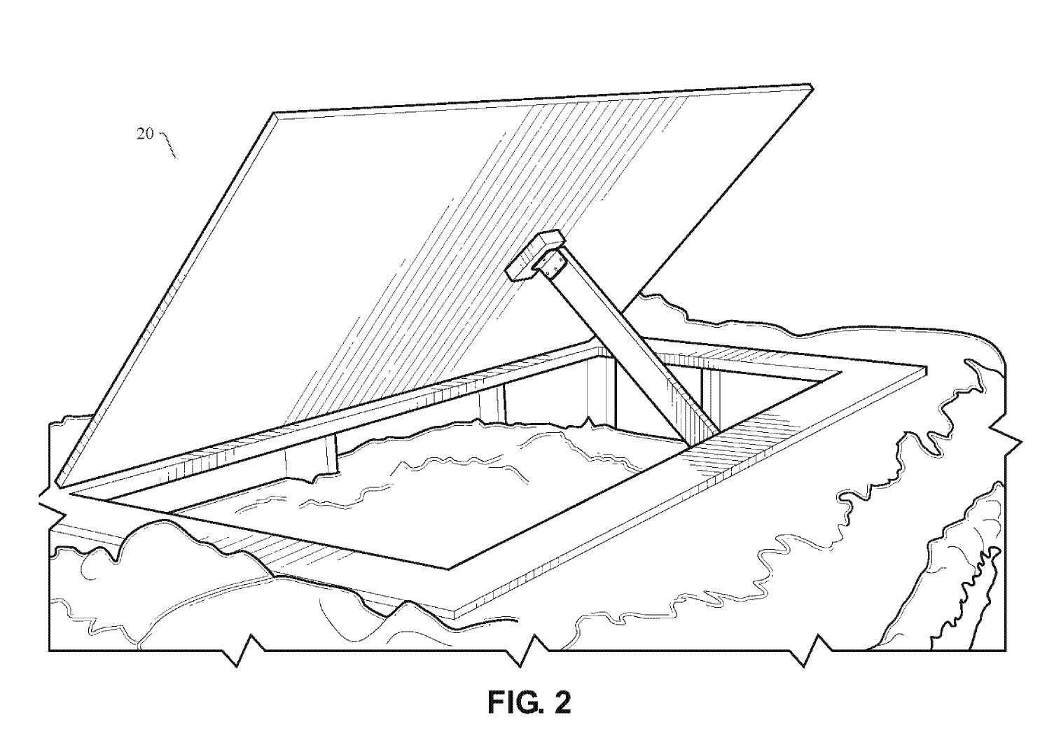

In a third step of the alpaca organic plant food formulation process of an example embodiment, the gathered and screened alpaca manure can be stored in a ventilated holding box until enough manure is obtained for further processing. FIG. 2 illustrates a ventilated holding box 20 according to an example embodiment. In typical practice of the disclosed process, the screened manure can be stored in the ventilated holding box 20 for approx. three months to await further processing. It will be apparent to those of ordinary skill in the art in view of the disclosure herein that the screened manure can be stored in the ventilated holding box 20 for a greater or lesser amount of time.

In a fourth step of the alpaca organic plant food formulation process of an example embodiment, the screened manure can be retrieved from the ventilated holding box 20 and washed with water to remove debris, sand, hay, bedding material, and other contaminants.

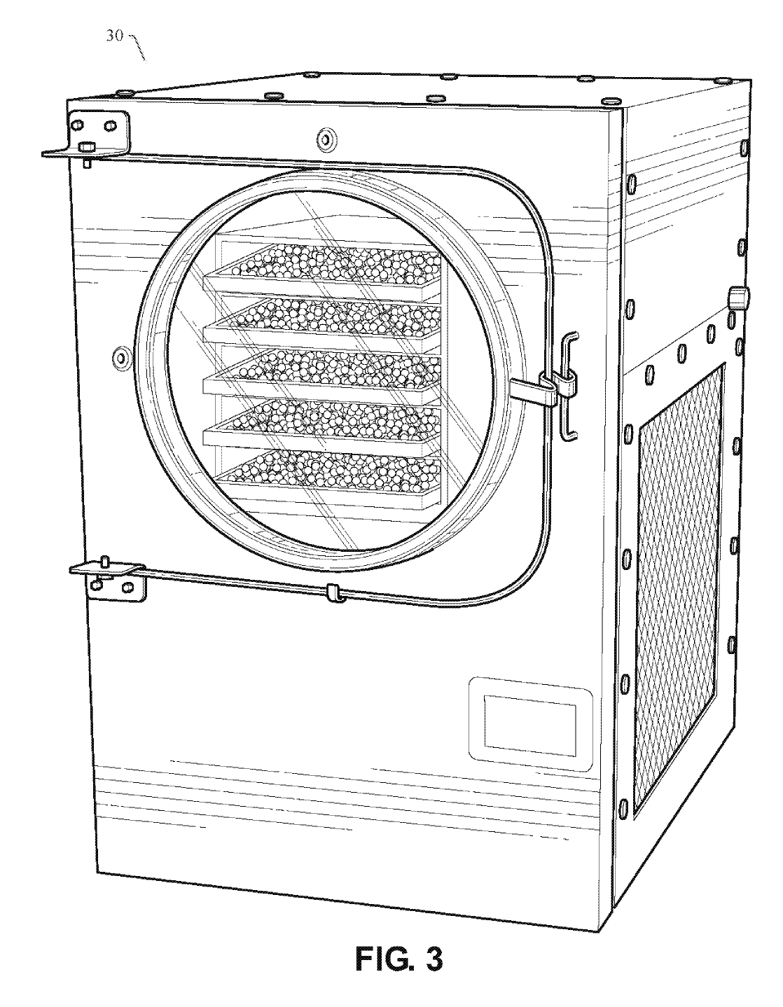

In a fifth step of the alpaca organic plant food formulation process of an example embodiment, the screened and washed alpaca manure can be loaded into a freeze-dryer machine and freeze-dried. FIG. 3 illustrates a freeze-dryer machine 30 according to an example embodiment. In an example embodiment, the screened and washed alpaca manure can be placed on multiple trays or racks configured to fit into the freeze-dryer machine 30 as shown in FIG. 3. In a particular embodiment, the trays or racks are of the dimensions 12 inches by 18 inches. Once the alpaca manure s loaded on the trays or racks and inserted into the freeze-dryer machine 30, the temperature in the freeze-dryer machine 30 can be lowered to 40 degrees F. below zero for 12 hours, then the temperature can be raised to 30 degrees F. below zero for 12 hours, then the temperature can be raised to 20 degrees F. below zero for eight hours. At this point, the freeze-dryer machine 30 can be configured to begin a vacuum cycle. Once the temperature of the alpaca manure in the freeze-dryer machine 30 hits 20 degrees F. below zero, the vacuum of the freeze-dryer machine 30 is activated and the alpaca manure is held in a vacuum state at 20 degrees F. below zero for the eight hours. This process of freezing and drying the alpaca manure in stages over a period of time serves to preserve the valuable nutrients in the alpaca manure. In other embodiments, the temperature of the alpaca manure can be lowered to 40 degrees F. below zero and then slowly raised over a period of approx. 30 to 32 hours to maintain all the valuable nutrients in the formulation. In contrast, mere dryers or dehydrators will destroy the nutrients in the formulation.

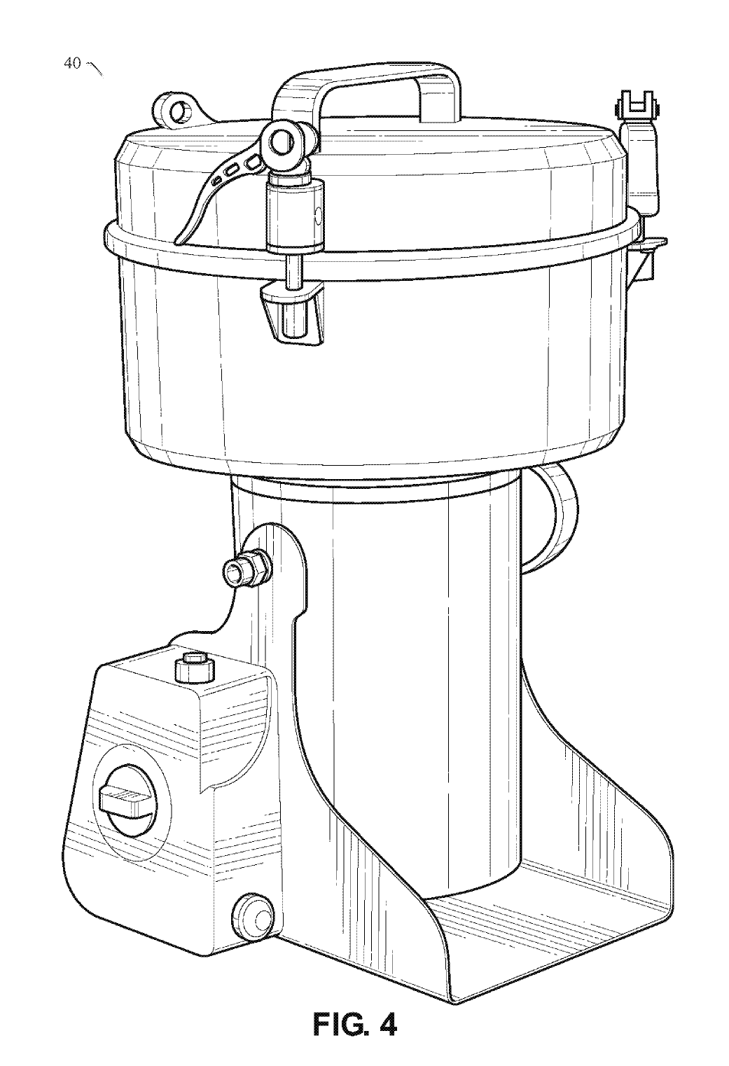

In a sixth step of the alpaca organic plant food formulation process of an example embodiment, the freeze-dried alpaca manure can be removed from the freeze-dryer machine 30 and loaded into a grinder. FIG. 4 illustrates a grinder or grinding apparatus 40 according to an example embodiment. After loading the freeze-dried alpaca manure into the grinder 40, the freeze-dried alpaca manure can be ground into a fine powder form using the grinder 40. In the example embodiment, the freeze-dried alpaca manure can be ground to a desired or configured consistency using the grinder 40.

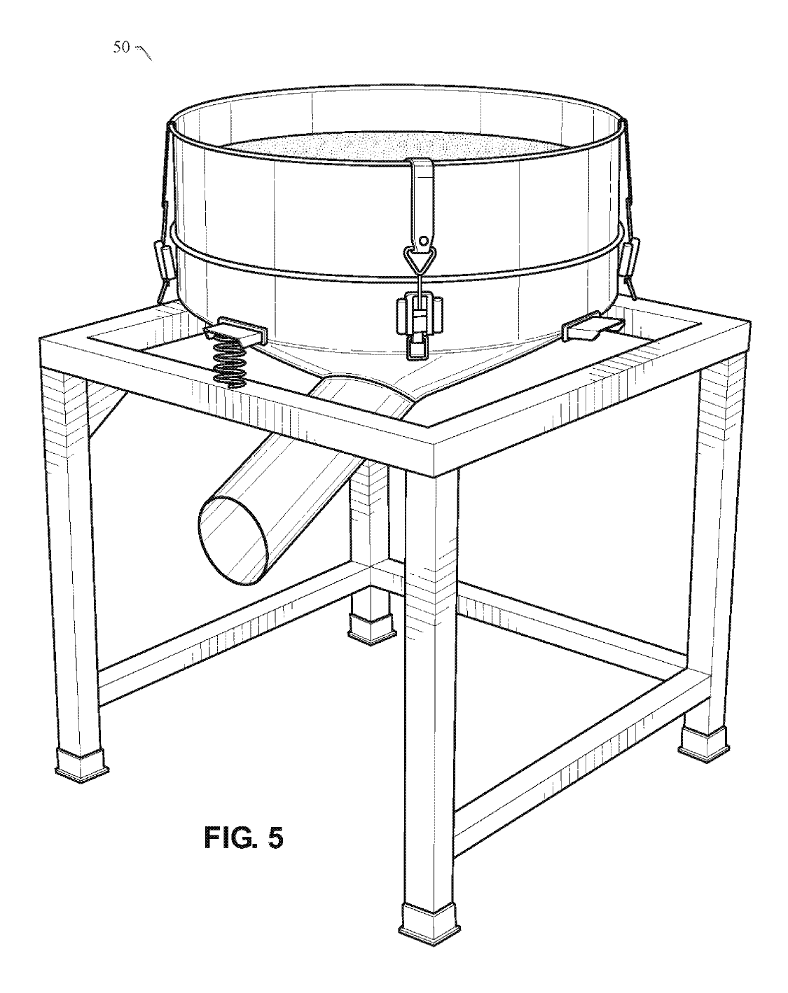

In a seventh step of the alpaca organic plant food formulation process of an example embodiment, the freeze-dried and ground alpaca manure powder can be sifted to remove unwanted chunks of material. FIG. 5 illustrates a sifter or automatic sifting apparatus 50 according to an example embodiment. In an example embodiment, the sifter 50 includes a sifting screen on an automatic sifting table that is 24 inches round as shown in FIG. 5. The sifter 50 can be used to screen and sift the ground alpaca manure powder to remove large chunks and produce a powdered material with a uniform consistency. In some cases, the ground alpaca manure may need to be screened and sifted more than once using the sifter 50 to obtain the desired consistency in the powdered alpaca manure.

In an eighth step of the alpaca organic plant food formulation process of an example embodiment, the powdered alpaca manure is combined or blended with worm castings. Worm castings are an organic form of fertilizer typically produced from earthworms. Also known as vermicast, worm castings manure is essentially earthworm waste. As these creatures eat through compost, their waste creates an optimal soil enricher. Adding worm castings manure to the soil aerates and improves its overall structure while providing beneficial nutrients to plants. Worm castings are also effective for repelling many pests that feed on plants, such as aphids and spider mites. In the eighth step of the process, the alpaca organic plant food formulation of the example embodiments combines two of the best known organic fertilizers to create a super soil for anything that grows. These two materials (alpaca manure and worm castings) offer a completely balanced long term nutritional formula. In the example embodiment, the freeze dried, ground, and sifted alpaca manure powder is combined with worm castings in a commercial food processor to form the alpaca organic plant food formulation. In an example embodiment, the alpaca manure powder is blended with worm castings in a ratio of 56% alpaca manure powder to 44% worm castings to form the alpaca organic plant food formulation. It will be apparent to those of ordinary skill in the art in view of the disclosure herein that the ratio of alpaca manure powder to worm castings can be varied as needed.

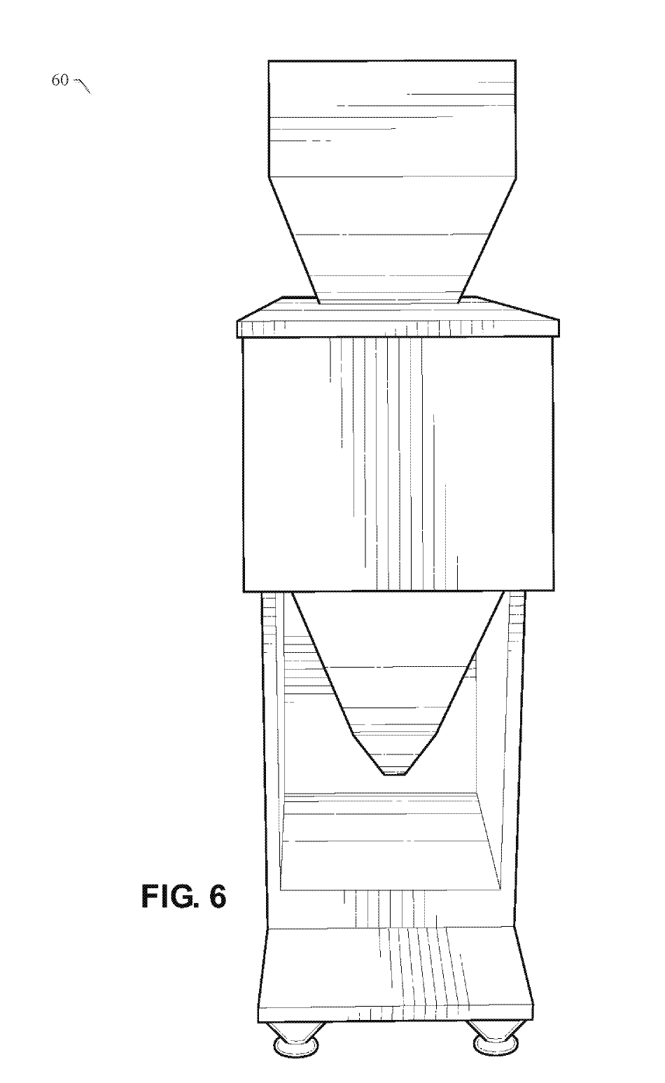

In a ninth step of the alpaca organic plant food formulation process of an example embodiment, the blended alpaca manure powder with worm castings or the alpaca organic plant food formulation can be packaged using a powder filling machine. FIG. 6 illustrates a powder filling machine 60 according to an example embodiment. The blended powder of alpaca manure and worm castings can be poured into the top of the powder filling machine 60 where the powder is weighed and packaged. In example embodiments, the powdered alpaca organic plant food formulation can be filled into packaging of various sizes using the powder filling machine 60.

Thus, as described in various example embodiments, a system and method for alpaca organic plant food formulation are disclosed. By virtue of the systems and methods described herein, several benefits are realized from the alpaca organic plant food formulation of the example embodiments. Some of these benefits are listed below.

1) The alpaca organic plant food formulation of the example embodiments described herein has no chemicals or hazardous materials. The formulation is organic.

2) The alpaca organic plant food formulation of the example embodiments can offer 15% to 30% better growth visually in ten days.

3) The alpaca organic plant food formulation of the example embodiments facilitates crop management by providing better soil conditioners for future root growth.

4) The alpaca organic plant food formulation of the example embodiments enables water conservation. Less water is used because plants are more efficient after application of the alpaca organic plant food formulation.

5) The alpaca organic plant food formulation of the example embodiments facilitates transportation of fertilizer; because, the formulation is compact, water-free, and concentrated. Thus, the formulation can be easily transported in high volume with less weight.

6) The alpaca organic plant food formulation of the example embodiments does not smell and does not produce unpleasant odors. In contrast, fertilizers made with fish, bat guano, cattle manure, or the like, will produce unpleasant odors.

7) Alpaca are South American Deer and all other deer are repelled by the smell of their own manure. Thus, the alpaca organic plant food formulation of the example embodiments does not attract deer, which can destroy planting environments.

8) In combination with worm castings, the alpaca organic plant food formulation of the example embodiments combines two of the best known organic fertilizers to create a super soil for anything that grows. These two materials (alpaca manure and worm castings) offer a completely balanced long term nutritional formula.

9) The alpaca organic plant food formulation of the example embodiments cannot be over fertilized. For example, a user can pour eight ounces of the formulation on one spot on a lawn and the formulation will not burn the lawn.

10) The alpaca organic plant food formulation of the example embodiments is completely odor-free and dry.

11) The alpaca organic plant food formulation of the example embodiments is completely free of weed seeds. As a result, a user does not have to use a herbicide to kill weeds for at least one month after application of the alpaca fertilizer. Fertilizers produced from the waste of other farm animals can contaminate a planting environment with unwanted weeds. For example, cattle manure is a significant weed producer.

12) The alpaca organic plant food formulation of the example embodiments has a shelf life of at least 25 years, even if the packaging is opened. The formulation does not require an expiration date or a use-by date.

13) The application of the alpaca organic plant food formulation of the example embodiments in a planting environment is not labor intensive. The formulation of the example embodiments can be spread in a ration of seven to eight ounces of the formulation per acre. The formulation can be sprayed on the acreage and does not need to be applied using a drop on method.

14) The application of the alpaca organic plant food formulation of the example embodiments will not harm collateral animals, wildlife, or vegetation with any excess runoff.

15) The application of the alpaca organic plant food formulation of the example embodiments does not require the user to rototill the formulation into the soil. Irrigation or precipitation will transfer the formulation of the example embodiments to the plant roots.

16) The production of the alpaca organic plant food formulation of the example embodiments results in time savings, relative to the production of other types of fertilizers. For example, composting takes five to eight weeks at 120 degrees to eliminate the pathogens, such as listeria or salmonella that cause food borne illnesses.

17) The production of the alpaca organic plant food formulation of the example embodiments uses freeze-drying, which causes the valuable nutrients to remain intact.

18) The alpaca organic plant food formulation of the example embodiments promotes the beneficial growth of micro-organisms.

19) The application of the alpaca organic plant food formulation of the example embodiments will not cause plant leaves to burn when the sun hits the leaves.

20) The alpaca organic plant food formulation of the example embodiments described herein produces healthy soils and is beneficial for the environment.

These and other advantages of the alpaca organic plant food formulation of the example embodiments are realized when the formulation process of the described embodiments is practiced as described herein.

FIG. 10 illustrates a flow diagram representing a sequence of operations performed in a method according to an example embodiment. In accordance with the example method 1000, the method comprises: feeding alpaca with second cut hay to eliminate weed seed in manure produced by the alpaca (operation 1010); gathering and screening the alpaca manure using a large mesh screen (operation 1020); storing the screened alpaca manure in a ventilated holding box (operation 1030); retrieving the screened alpaca manure from the ventilated holding box and washing the screened alpaca manure with water to remove debris (operation 1040); loading the screened and washed alpaca manure into a freeze-dryer machine and freeze-drying the alpaca manure in stages over a period of time (operation 1050); loading the freeze-dried alpaca manure into a grinder and grinding the alpaca manure into a fine powder form using the grinder (operation 1060); sifting the ground alpaca manure powder using a sifter to remove unwanted chunks of material (operation 1070); combining the sifted powdered alpaca manure with worm castings to form an alpaca organic plant food formulation (operation 1080); and packaging the alpaca organic plant food formulation using a powder filling machine (operation 1090).

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used only for descriptive purposes and not to be construed as limiting. The elements, materials, geometries, dimensions, and sequence of operations may all be varied for particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, a system and method for alpaca organic plant food formulation is disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. A method comprising:
feeding alpaca with second cut hay to eliminate weed seed in manure produced by the alpaca;
gathering and screening the alpaca manure using a large mesh screen;
storing the screened alpaca manure in a ventilated holding box;
retrieving the screened alpaca manure from the ventilated holding box and washing the screened alpaca manure with water to remove debris;
loading the screened and washed alpaca manure into a freeze-dryer machine and freeze-drying the alpaca manure in stages over a period of time;
loading the freeze-dried alpaca manure into a grinder and grinding the alpaca manure into a fine powder form using the grinder;
sifting the ground alpaca manure powder using a sifter to remove unwanted chunks of material;
combining the sifted powdered alpaca manure with worm castings to form an alpaca organic plant food formulation; and
packaging the alpaca organic plant food formulation using a powder filling machine.

2. The method of claim 1 wherein the large mesh screen is a ¼ inch large mesh screen.

3. The method of claim 1 wherein the screened alpaca manure is stored in the ventilated holding box for at least three months.

4. The method of claim 1 wherein loading the screened and washed alpaca manure into the freeze-dryer machine further includes placing the alpaca manure on a plurality of trays configured to fit into the freeze-dryer machine.

5. The method of claim 1 wherein freeze-drying the alpaca manure in stages over a period of time includes lowering the temperature in the freeze-dryer machine to at least 40 degrees F. below zero for at least 12 hours.

6. The method of claim 1 wherein freeze-drying the alpaca manure in stages over a period of time includes lowering the temperature in the freeze-dryer machine to at least 40 degrees F. below zero for at least 12 hours and then raising the temperature in the freeze-dryer machine to at least 30 degrees F. below zero for at least 12 hours.

7. The method of claim 1 wherein freeze-drying the alpaca manure in stages over a period of time includes lowering the temperature in the freeze-dryer machine to at least 40 degrees F. below zero for at least 12 hours and then raising the temperature in the freeze-dryer machine to at least 30 degrees F. below zero for at least 12 hours and then raising the temperature in the freeze-dryer machine to at least 20 degrees F. below zero for at least 12 hours.

8. The method of claim 1 wherein freeze-drying the alpaca manure in stages over a period of time includes lowering the temperature in the freeze-dryer machine to at least 40 degrees F. below zero and then slowly raising the temperature over a period of at least 30 hours.

9. The method of claim 1 wherein combining the sifted powdered alpaca manure with worm castings includes blending the alpaca manure powder with worm castings in a ratio of 56% alpaca manure powder to 44% worm castings.

10. The method of claim 1 wherein packaging the alpaca organic plant food formulation using a powder filling machine includes filling packaging of various sizes using the powder filling machine
